(19) United States
(12) Patent Application Publication
(10) Pub. No.: US 2019/0356788 A1
(43) Pub. Date: Nov. 21, 2019

(54) APPARATUS AND METHOD OF PROVIDING PHOTO PRINTING CAMERA APPLICATION, AND PHOTO PRINTING SERVICE PROVIDING SYSTEM USING SHARED FILM

(71) Applicant: TAEOA CO., LTD., Seongnam-si (KR)

(72) Inventor: Seung Ho OH, Seongnam-si (KR)

(21) Appl. No.: 16/050,042

(22) Filed: Jul. 31, 2018

(30) Foreign Application Priority Data
May 21, 2018 (KR) 10-2018-0057733
Jul. 10, 2018 (KR) 10-2018-0080171

(51) Int. Cl. H04N 1/00; G06Q 30/06

(52) U.S. Cl. CPC H04N 1/00167; H04N 1/00137; H04N 5/23216; G06Q 30/0641; G06Q 30/0643; H04N 1/00145

(57) ABSTRACT

Provided are an apparatus and method of providing a photo printing camera application and a photo printing service system using a shared film, and the apparatus includes a processor that executes a photo printing camera application program stored in a memory, and the processor provides a photographing user interface including a first region outputting an image of a slot from a virtual film including multiple slots and a second region outputting a photograph taken with a camera module, and if photographing is performed through the photographing user interface, the processor assigns the photograph output on the second region to the slot output on the first region and exhausts the slot, and transmits a request for photo printing including photograph data for each slot stored in the virtual film to at least one of a photo printing service server, a photo printing provider device, and a photo printing kiosk.

### TECHNICAL FIELD

The present disclosure relates to an apparatus and method of providing a camera application that performs photographing and photo printing using a virtual film, and a photo printing service system including an apparatus and server of providing a photo printing service using a virtual film (hereinafter, referred to as “shared film”) shared by a large number of people.

### BACKGROUND

With the development of mobile communication technology and high prevalence of portable devices (e.g., mobile devices) equipped with a camera module, anyone can enjoy photographing anywhere and anytime. A photograph taken with a portable device can be freely printed and shared online. However, in order to have an offline printed photograph like a photograph taken with a film camera, it is required to use a separate online printing service.

In this regard, Korean Patent Laid-open Publication No. 10-2016-0044667 (entitled “Printing system for a photograph using a mobile phone”) discloses a photo printing system using a user device, including a printing device configured to print a photograph stored at a position corresponding to photograph location information in a printing format corresponding to printing format information, a printing management server configured to transmit the photograph location information and the printing format information to the printing device, and a user device configured to execute a photo printing application that recognizes the printing device, selects a photograph to be printed and provides the photograph to the printing management server with a request for photo printing.

Such a conventional online photo printing service method requires a user to select each photograph to be printed among multiple photographs stored in a portable device and upload the selected photograph to a printing service server in order to print a photograph.

Accordingly, there is a need for a technology that enables a user to easily take and manage a photograph for printing with a portable device and make a request online for printing of multiple photographs for each film at one time in a similar way to an analog film camera.

Further, according to the conventional online photo printing service method, if a large number of members want to have a photograph taken with a portable device, the photograph needs to be taken multiple times according to the number of the members or when photo printing is requested, printing of the same photograph needs to be requested multiple times.

Accordingly, there is a need for a technology that enables multiple users to share a certain film online and perform photographing and easily make a request for photo printing.

### SUMMARY

In view of the foregoing, the present disclosure provides an apparatus and method of providing a camera application with a photographing function using a virtual film and a photo printing function and the camera application enables photographing, printing, and delivery.

Further, the present disclosure provides an apparatus of providing a photo printing camera application that enables photographs taken using a virtual film (i.e., shared film) shared by multiple users to be printed for and delivered to all of the sharing members, and a photo printing service system including a photo printing service server interworking with the apparatus and a method thereof.

However, problems to be solved by the present disclosure are not limited to the above-described problems. There may be other problems to be solved by the present disclosure.

According to a first aspect of the present disclosure, an apparatus that provides a photo printing camera application includes: a camera module; a communication module; a memory that stores a photo printing camera application program; and a processor that executes the program stored in the memory. Herein, upon execution of the photo printing camera application program, the processor provides a photographing user interface including a first region on which an image of a slot to be currently used from a virtual film including multiple slots that store photograph data is output and a second region on which a photograph taken with the camera module is output, and if photographing is performed through the photographing user interface, the processor assigns the photograph output on the second region to the slot output on the first region and exhausts the slot, and transmits a request for photo printing including photograph data for each slot stored in the virtual film to at least one of a photo printing service server, a photo printing provider device, and a photo printing kiosk through the communication module.

According to a second aspect of the present disclosure, a method of providing a photo printing camera application includes: providing a photographing user interface including a first region on which an image of a slot to be currently used from a virtual film including multiple slots that store photograph data is output and a second region on which a photograph taken with a camera module is output; if photographing is performed through the photographing user interface, assigning the photograph output on the second region to the slot output on the first region and exhausting the slot; and transmitting a request for photo printing including photograph data for each slot stored in the virtual film to at least one of a photo printing service server, a photo printing provider device, and a photo printing kiosk.

According to a third aspect of the present disclosure, an apparatus that provides a photo printing camera application includes: a camera module; a communication module; a memory that stores a photo printing camera application program configured to perform photographing and photo printing services using a shared film; and a processor that executes the program stored in the memory. Herein, upon execution of the photo printing camera application program, the processor provides a photographing user interface that enables photographing with a shared film which is shared with one or more other members and includes multiple slots that individually store photograph data, stores a photograph taken with the camera module in an unused slot among the multiple slots and exhausts the slot, transmits photograph data for each slot stored in the shared film to at least one of a photo printing service server, a photo printing provider device, and a photo printing kiosk which are already interworking with the processor in order for a photograph to be printed for each of the members sharing the shared film, and transmits used slot information about an exhausted slot to the photo printing service server whenever a photograph is taken using the shared film, and if the processor receives shared information about a slot exhausted when the shared film is used by user devices of the other members from the photo printing service server in real time, the processor synchronizes an exhaustion process for a slot corresponding to the shared information on the shared film.

According to a fourth aspect of the present disclosure, a photo printing service server interworking with a user device that provides a photo printing camera application using a shared film includes: a communication module; a memory that stores a photo printing service program; and a processor that executes the photo printing service program. Herein, upon execution of the photo printing service program, the processor matches each user device that purchases a shared film with user identification information, information about the purchased shared film, and identification information of each member sharing the shared film and stores them, and if the processor receives a request for photo printing including photograph data stored in at least some of multiple slots of a shared film from a previously registered user device, the processor checks previously stored identification information of other multiple members for the shared film requested for photo printing, transmits a request for photograph data of the shared film to user devices of the other members based on the checked identification information of the other members, and receives photograph data for each slot used in the shared film from at least one of the user devices of the other members in response to the request for photograph data, and when photograph data of all slots in the shared film requested for photo printing are completely received, the processor performs a predetermined photo printing process. Further, the shared film is shared by two or more members and includes multiple slots that individually store photograph data.

According to the present disclosure, it is possible to provide a camera application with a photographing function and a photo printing function. That is, it is possible to provide a camera application in which if a user pays in advance for the number of times the user can print a photograph, when the user takes photographs, the photographs can be taken, printed, and delivered without a separate photo selection process. Thus, there is no need for the user to select each photo to be printed among multiple photographs taken previously and upload the selected photograph to an online printing server, and, thus, the user can directly take photographs and upload the photographs in a virtual film for printing to a printing server. Further, when a photograph is taken using a virtual film, the user can edit a desired comment into a desired design and insert the edited comment into the photograph. When a virtual film is used, virtual films having various characteristics can be freely replaced and applied. Further, it is possible to provide a function to give another user a virtual film for a gift.

According to the present disclosure, a large number of members can share a virtual film and use photographing a photo printing services. As such, a photo printing service using a drive-type shared film is provided in order for a large number of members to access and use the shared film. Thus, it is possible to overcome various problems (e.g., need to take a photograph only with a specific device, need to make a payment again on another device, need to take a photograph multiple times according to the number of members or make a request for photo printing multiple times in order to distribute the photograph to each member, etc.) which may occur when a virtual film can be used only by one device. That is, a group including multiple members such as a family, a couple, friends, etc. can share a virtual film and take photographs, and the photographs taken using the film can be printed for and provided to all members of the group.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 is a configuration diagram showing a photo printing camera application service system in accordance with various embodiments described herein.

FIG. 2 illustrates an example of a user interface provided through a photo printing camera application in accordance with various embodiments described herein.

FIG. 3 and FIG. 4 illustrate examples of a user interface to explain a process of selling a virtual film through a photo printing camera application in accordance with various embodiments described herein.

FIG. 5 illustrates an example of a user interface to explain a process of inputting a comment into a photograph through a photo printing camera application in accordance with various embodiments described herein.

FIG. 6 illustrates an example of a user interface to explain a virtual film development process through a photo printing camera application in accordance with various embodiments described herein.

FIG. 7 illustrates an example of a user interface to explain a photograph management method on a virtual film through a photo printing camera application in accordance with various embodiments described herein.

FIG. 8 illustrates an example of a user interface to explain a method of making a request for photo printing through a photo printing camera application in accordance with various embodiments described herein.

FIG. 9 is a flowchart provided to explain a method of providing a photo printing camera application in accordance with various embodiments described herein.

FIG. 10 is a configuration diagram showing a photo printing service system using a shared film in accordance with various embodiments described herein.

FIG. 11 illustrates an example of a user interface to explain a photograph management method on a shared film through a photo printing camera application in accordance with various embodiments described herein.

FIGS. 12A and 12B illustrate an example of a user interface to explain a slot exhaustion synchronization method for a shared film through a photo printing camera application in accordance with various embodiments described herein.

FIG. 13 is a flowchart provided to explain a photo printing service method using a shared film through a photo printing camera application in accordance with various embodiments described herein.

### DETAILED DESCRIPTION

Hereinafter, embodiments of the present disclosure will be described in detail with reference to the accompanying drawings so that the present disclosure may be readily implemented by those skilled in the art. However, it is to be noted that the present disclosure is not limited to the embodiments but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element. Further, it is to be understood that the term “comprises or includes” and/or “comprising or including” used in the document means that one or more other components, steps, operation and/or existence or addition of elements are not excluded in addition to the described components, steps, operation and/or elements unless context dictates otherwise.

Through the whole document, the term “unit” includes a unit implemented by hardware or software and a unit implemented by both of them. One unit may be implemented by two or more pieces of hardware, and two or more units may be implemented by one piece of hardware.

Through the whole document, the term “device” or “user device” may refer to a wireless communication device that ensures portability and mobility and may include all kinds of handheld-based wireless communication devices such as a PCS device, a tablet PC, and the like. Further, the “device” may also refer to a wired communication device such as a PC which can access a server or another device through a network.

Hereinafter, an apparatus and method of providing a photo printing camera application according to an embodiment of the present disclosure will be described in detail with reference to the accompanying drawings.

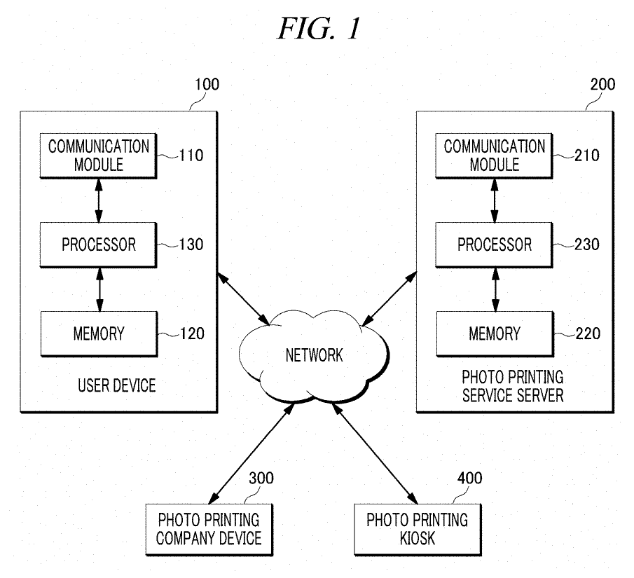

As illustrated in FIG. 1, a photo printing camera application service system includes a user device 100, a photo printing service server 200, a photo printing provider device 300, and a photo printing kiosk 400.

Herein, the user device 100 may be an intelligent device, such as a smartphone, in which various functions are provided or various programs (e.g., mobile applications, etc.) can be freely provided and installed, and provides a photo printing camera application.

As shown in FIG. 1, the user device 100 includes a communication module 110, a memory 120, and a processor 130.

The communication module 110 performs data communication with each of the photo printing service server 200, the photo printing provider device 300, and the photo printing kiosk 400 under the control of the processor 130.

The memory 120 stores a photo printing camera application program.

Herein, the memory 120 may collectively refer to a non-volatile storage device that retains information stored therein even when power is not supplied and a volatile storage device that requires power to retain information stored therein.

The photo printing camera application program stored in the memory 120 is driven by the processor 130.

Further, the memory 120 may function to temporarily or permanently store data processed by the processor 130. Herein, the memory 120 may include magnetic storage media or flash storage media in addition to the volatile storage device that requires power to retain information stored therein, but the present disclosure is not limited thereto.

The procedure of a service provided through the photo printing camera application according to an embodiment of the present disclosure can be roughly described as follows.

A user may purchase online a virtual film capable of taking and storing multiple photographs through the photo printing camera application in the user device 100. Herein, the purchase of the virtual film may include payment for a photo printing service for photograph data stored in the film. Then, the user may select the virtual film purchased though the user device 100 and take a photograph. All of a predetermined number of slots in the virtual film may be exhausted, or a request for photo printing for photograph data stored in the virtual film may be transmitted to the photo printing service server 200 or the like through the photo printing camera application according to the user's choice.

To provide the photo printing camera application, the processor 130 performs the following processes when the photo printing camera application program is executed.

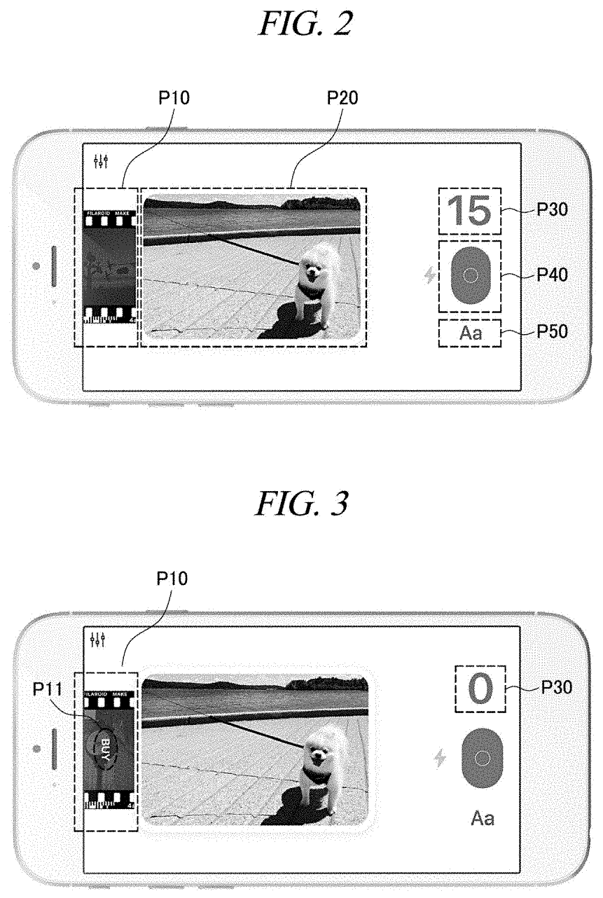

The processor 130 provides a photographing user interface including a first region on which an image of a slot to be currently used from a virtual film including multiple slots that store photograph data is output and a second region on which a photograph taken with a camera module is output. Further, if photographing is performed through the photographing user interface, the processor 130 assigns a photograph output on the second region to a slot output on the first region and exhausts the slot. Then, the processor 130 transmits a request for photo printing including photograph data for each slot stored in the virtual film to at least one of the photo printing service server 200, the photo printing provider device 300 (displayed as “photo printing company device” in FIG. 1), and the photo printing kiosk 400 through the communication module 110. For reference, the user interface provided through the photo printing camera application according to an embodiment of the present disclosure has a concept including a graphic user interface (GUI). The method of providing the photo printing camera application by the processor 130 will be described in detail later with reference to FIG. 2 to FIG. 8.

As shown in FIG. 1, the photo printing service server 200 includes a communication module 210, a memory 220, and a processor 230.

The communication module 210 performs data communication with each of the user device 100 and the linked photo printing provider device 300 and photo printing kiosk 400.

The memory 220 stores a photo printing camera application program configured to provide a photo printing camera application service to the user device 100.

The processor 230 executes the program stored in the memory 220 and performs processes corresponding to respective operations of the photo printing camera application program to be processed by the processor 130 of the user device 100. The operations to be processed by the processor 130 and the operations of the user device 100 will be described later with reference to FIG. 2 to FIG. 8.

Each of the photo printing provider device 300 and the photo printing kiosk 400 is a device managed or installed in a certain place and receives a virtual film (including multiple photograph data) provided through the user device 100 or the photo printing service server 200. Each of a printing company (i.e., photo printing provider) that manages the photo printing provider device 300 and the photo printing kiosk 400 can perform photo printing for the received virtual film, package a printed photograph as a product, and deliver the photograph product using delivery information set for each virtual film. Further, the printing provider or the photo printing kiosk may transfer the packaged photograph product to a user who visits the printing provider or the photo printing kiosk offline, through an authentication process.

Hereinafter, general functions of the photo printing camera application provided under the control of the processor 130 will be described with reference to FIG. 2.

FIG. 2 illustrates an example of a user interface provided through a photo printing camera application in accordance with an embodiment of the present disclosure.

Referring to FIG. 2, a user interface of the photo printing camera application output on a screen includes a first region P10 on which an image of any one slot of a virtual film being currently selected (i.e., being used). Further, the user interface includes a second region P20 where an image being taken or already taken with a camera module (not illustrated) provided in the user device 100 is displayed. Furthermore, the user interface may include a third region P30 where the number of available slots remaining in the virtual film is displayed, a fourth region P40 where a camera button to control camera photographing is displayed, and a fifth region P50 where a comment button that enables the user to input a comment into the photograph is displayed.

Herein, if a predetermined user interactive action (e.g., click, swipe, slide, etc.) occurs on a slot image output on the first region P10, the processor 130 may provide a film replacement user interface that enables the user to replace the film with another one of multiple virtual films purchased by the user. For example, if the user swipes up and down on the slot of the virtual film output on the photographing user interface, the film can be replaced with another one of multiple virtual films purchased by the user. In this case, each of the virtual films may have different characteristics, and by replacing the film, the user can select a film with his/her desired emotional effect and take a photograph.

Further, the user is highly likely to click the camera button by mistake. Therefore, when the camera button P40 is used, if a certain condition (e.g., double clicking the camera button, pressing the camera button for a predetermined period until a gauge is filled, or inserting a separate OK button) is satisfied, the processor 130 may provide an automatic photography prevention mode to check whether or not photographing is completed. The automatic photography prevention mode can be turned on or off in a process to prepare photographing or can be collectively applied through a separate setting screen.

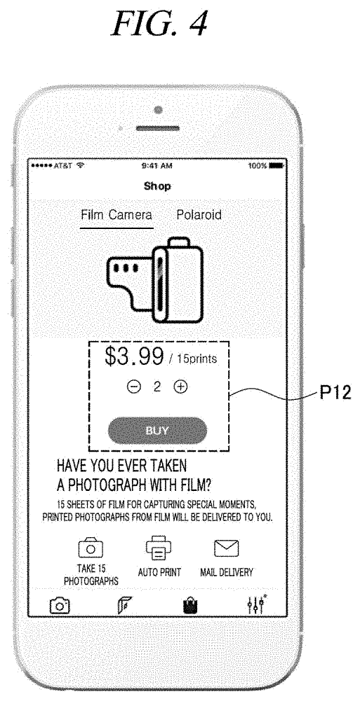

A process of handling the purchase of a virtual film by the processor 130 will be described with reference to FIG. 3 and FIG. 4.

FIG. 3 and FIG. 4 illustrate examples of a user interface to explain a process of selling a virtual film through a photo printing camera application in accordance with an embodiment of the present disclosure.

If there is no virtual film registered (i.e., purchased virtual film) for the user of the user device 100 or if there is no slot remaining in a currently selected virtual film among previously purchased virtual films, the processor 130 may output a buy button to a virtual film UI on the first region P10 of the screen.

For example, FIG. 3 illustrates that when there is no slot remaining in a currently selected virtual film, the number of slots is displayed “0” on the third region P30 and a buy button P11 is displayed as “BUY” on the first region P10. In this case, the user can select (e.g., click) the button and intuitively and easily determine the purchase of a virtual film.

As such, if the virtual film buy button is selected, a virtual film purchase user interface is output as shown in FIG. 4.

The virtual film purchase user interface includes a sixth region P12 where virtual film information including price information of one or more virtual films, characteristic information of each virtual film, and the number of slots in each virtual film is output. The virtual film purchase user interface provides a function to select at least one virtual film and a function to make a payment for selected one or more virtual films. For reference, the characteristics of a virtual film may include various filter effects and the size of a photograph to be printed.

In this case, the processor 130 can make a payment for a virtual film through online payment with a credit card or by inputting the user's offline code in the form of a gift coupon.

Meanwhile, the processor 130 may provide a virtual film gift user interface that enables the user to give a virtual film for a gift to another user.

That is, the user of the user device 100 can give a virtual film for a gift by paying for the virtual film and inputting user identification information (e.g., ID or phone number) of a gift recipient (i.e., another user) or an unique code already issued to the gift recipient. Further, the gift recipient can take photographs using the virtual film and use a film printing service by inputting a delivery address.

Specifically, the virtual film gift user interface includes a menu to input information about a person to receive a virtual film for a gift, a menu to select the kind or price of a virtual film for a gift, and a menu to pay for the selected virtual film or price.

Herein, the results of the processes performed through the respective menus are transmitted to the photo printing service server 200. If the virtual film for a gift or the price of the virtual film is selected and paid, the photo printing service server 200 generates a virtual film activation code corresponding to the paid virtual film or price and transmits the virtual film activation code to a user device corresponding to the gift recipient.

The user device 100 that receives the virtual film activation code given by another user through the photo printing service server 200 may make a payment by inputting the virtual film activation code when purchasing the virtual film. Otherwise, the virtual film corresponding to the virtual film activation code can be registered directly as a purchased virtual film on the photo printing camera application of the user device 100.

Hereinafter, a process of inputting the user's comment into a photograph by the processor 130 will be described.

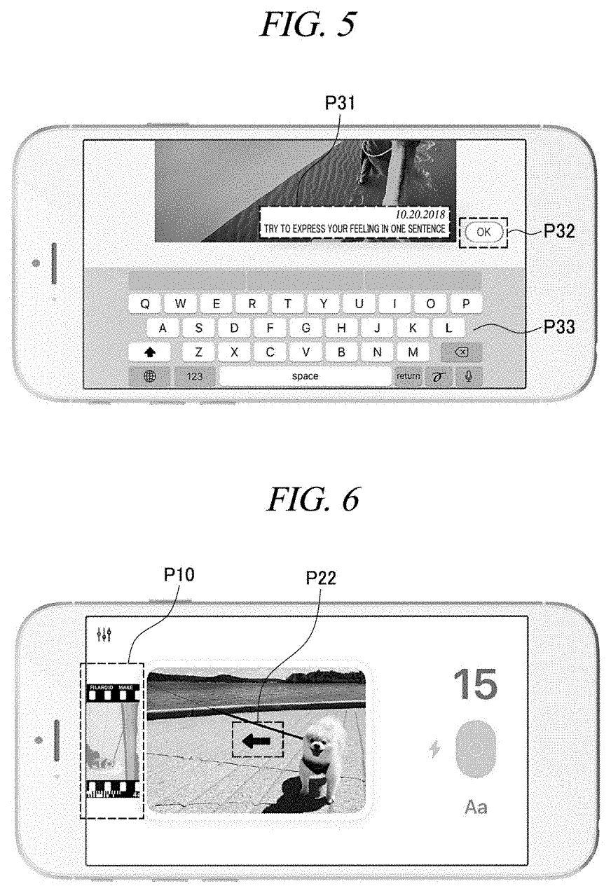

FIG. 5 illustrates an example of a user interface to explain a process of inputting a comment into a photograph through a photo printing camera application in accordance with an embodiment of the present disclosure.

The processor 130 provides the photographing user interface including the fifth region P50 where a comment input menu to input the user's desired text into a photograph is output.

When the comment input menu (e.g., “one-sentence comment” button) is selected, the photographing user interface further provides a user interface including a region P33 where a tool (e.g., keyboard) that enables the user to input a text is output, a region P31 where a text input by the user is output, and a region where a comment input complete menu P32 is output. As shown in FIG. 5, a position of the region 31 where a text input by the user is output can be selected and adjusted on the photograph by the user. Further, if the comment input complete menu P32 is selected, the text input by the user and photographing time information (i.e., date and time) can be marked on the photograph. Thus, the user can directly record a memo presenting his/her feeling or situation at the photographing time on the photograph and easily apply a comment of a desired design at a desired position.

FIG. 6 illustrates an example of a user interface to explain a virtual film development process through a photo printing camera application in accordance with an embodiment of the present disclosure.

If a predetermined user interactive action occurs on the photograph output on the second region P20, the processor 130 may mark the photograph on the second region P20 onto the slot of the virtual film output on the first region P10. In this case, the user interactive action may include at least one of click, swipe, and slide. Referring to FIG. 6, if the user interactive action (i.e., slide or drag and drop) P22 toward the slot image (i.e., first region) is input on the photograph, the photograph image is overlaid on the slot image output on the first region P10 and virtually film-developed.

In an embodiment of the present disclosure, the virtual film development logically refers to the assignment and storage of photograph data in a storage region corresponding to the slot of the virtual film and visually refers to the display of the photograph overlaid on the slot image. For example, when the photograph is marked on the slot image, the processor 130 may apply an opaque filter effect or a color change effect similar to a result of analog film development.

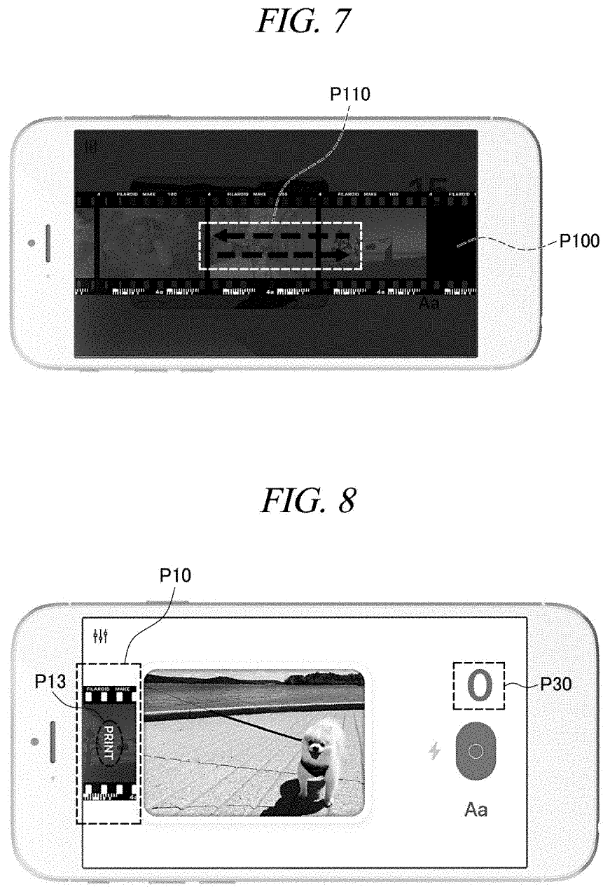

FIG. 7 illustrates an example of a user interface to explain a photograph management method on a virtual film through a photo printing camera application in accordance with an embodiment of the present disclosure.

The processor 130 provides a film check user interface that enables the user to select any one of purchased virtual films and output images of all slots in the selected virtual film in order to check the all slots in the selected virtual film.

For example, if the user clicks a slot image of a current used virtual film output on the first region P10 of the photographing user interface, the screen may be switched to a film check page to check all slots stored in the virtual film. That is, the film check user interface that enables the user to check all photographs stored in the virtual film may be provided. Herein, photographs may be displayed as overlaid on a slot to which virtual film development is completely performed among all slot images P100 and a basic image presenting an empty slot may be displayed on an unused slot.

Referring to FIG. 7, if a user interactive action P110 occurs according to a direction in which multiple slots are connected on the all slot images P100 of the virtual film output through the film check user interface, the processor 130 changes positions of the currently output slots of the virtual film according to the direction of the user interactive action (e.g., click, swipe, slide, etc.) and then outputs the slots. For example, the user can change a position of each slot in the virtual film by sliding up and down on the all slot images P100, and select (e.g., click) one of the currently output slots and separately enlarge, output and check a corresponding photograph image.

FIG. 8 illustrates an example of a user interface to explain a method of making a request for photo printing through a photo printing camera application in accordance with an embodiment of the present disclosure.

If all slots in a virtual film activated on the photographing user interface are exhausted or at least one slot of the activated virtual film is used and then the user makes an input to select and print a photograph, the processor 130 transmits a request for printing of the photograph.

In this case, the request for photo printing may be transmitted to at least one of the service server 200, the photo printing provider device 300, and the photo printing kiosk 400 according to the user's choice, or may be automatically transmitted to the service server 200 and then transferred to at least one of the photo printing provider device 300 and the photo printing kiosk 400 under the control of the service server 200.

Aside from the above process, the processor 130 performs a film backup function to avoid a situation where photographs are lost, such as the loss of the user device. In this case, when all slots in a virtual film are exhausted or according to the user's choice, the processor 130 performs a backup by uploading user identification information of the virtual film, identification information of the virtual film, and photograph data for each slot in the virtual film to the photo printing service server 200. Accordingly, the photo printing service server 200 performs a user authentication process to each user and matches each user with photograph data for each virtual film and stores them. For reference, the photo printing service server 200 stores therein a film purchase history of each user who purchases virtual films.

When the user purchases a virtual film or makes a request for photo printing, the processor 130 further provides a user interface that enables the user to input a delivery address at which the user receives printed photographs. Herein, the processor 130 transmits the input delivery address together with at least one of identification information of the user and identification information of the virtual film to the photo printing service server 200 to register them.

For example, the processor 130 may perform a photograph upload process of uploading all photographs in the virtual film to the service server 200, a delivery check process of outputting the input delivery address to be checked by the user when the user pays for the virtual film or makes a request for photo printing, a delivery change process of receiving a modified delivery address if the user wants to modify the delivery address, and an order complete process of finally completing an order of printing.

Herein, the processor 130 or the photo printing service server 200 may set a user identification photograph output menu to print a sheet of photograph including user information during printing. Thus, it is possible to avoid switching of photographs between users during packaging in each printing company or kiosk.

Further, before the order complete process, the processor 130 may provide a user interface that enables the user to add the number to the default number (e.g., “1” sheet) for each slot of the virtual film. Thus, it is possible for the user to select a slot to be printed in an additional number and set the additional number.

Thus, the photograph data to which an order of printing is completely made may be transmitted to the affiliated printing company or photo printing kiosk through the photo printing service server 200.

For reference, printed photographs may be primarily packaged in a branded film envelope of a photo printing service provider and secondarily packaged in a mail envelope or the like and then delivered to the user. The film envelope may have design elements to facilitate not only packaging but also storage of the photographs. For example, the film envelope may have a hole to be kept as hung on a hook and a date marked on the film envelope to indicate when the film is printed, and at least some of film envelopes may have different colors to distinguish years or months.

Meanwhile, the photo printing service server 200 may transmit a request for photo printing to the provider device 300 or photo printing kiosk 400 close or adjacent in distance to the user based on the delivery address input by the user.

To this end, each of the photo printing service provider device 300 and the photo printing kiosk 400 may include a communication module configured to perform data communication with the user device 100 or the photo printing service server 200, a processor configured to control a photo printing service, and a memory that stores a photo printing service program.

Further, when photo printing is requested, the processor 130 may be supplied with location information of one or more adjacent photo printing companies or kiosks from the service server 200 based on the location of the user device 100. Further, the processor 130 may output the provided list of location information of photo printing companies or kiosks and transmit a request for photo printing to the photo printing service provider device 300 or photo printing kiosk 400 selected by the user. In this case, the processor 130 may further provide a receipt reservation user interface that enables the user to schedule a visit to the photo printing service company or the photo printing kiosk to receive the printed photographs.

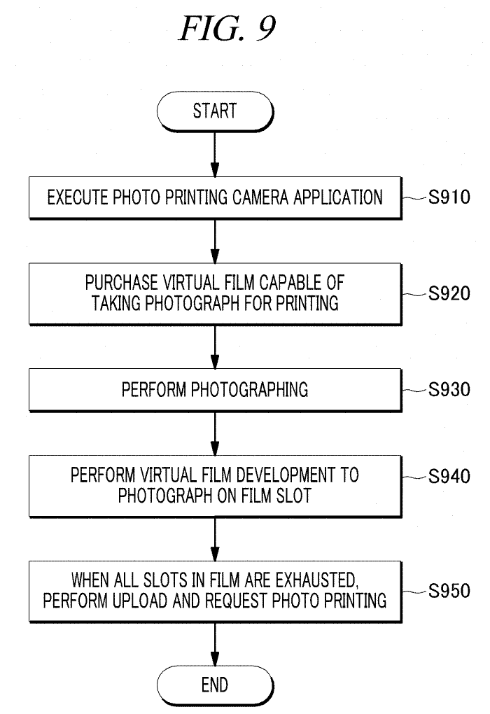

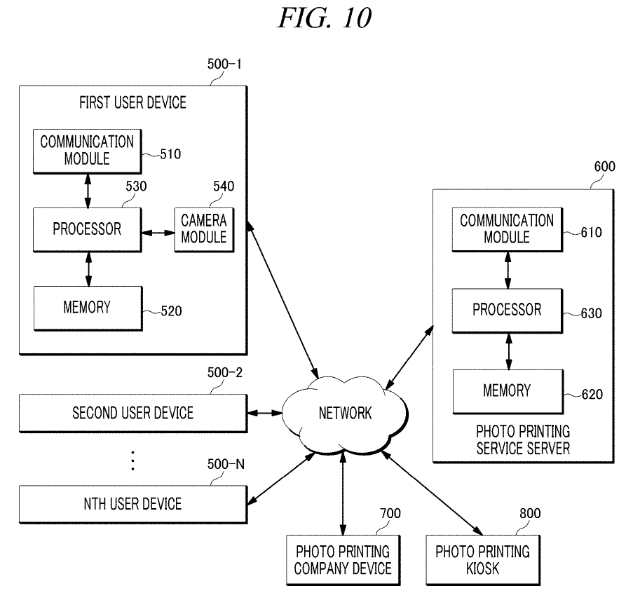

Hereinafter, a method of providing a photo printing camera application according to an embodiment of the present disclosure will be described in detail with reference to FIG. 9. The following processes can be performed by the processor 130 of the apparatus of providing a photo printing camera application (i.e., user device).

FIG. 9 is a flowchart provided to explain a method of providing a photo printing camera application in accordance with various embodiments described herein.

In a user device, a photo printing camera application is executed (S910).

In this case, the photo printing camera application program is provided in the user device and the photo printing camera application program can be downloaded by access to the photo printing service server, or can be downloaded from a separate market from which mobile applications can be downloaded.

Further, when the photo printing camera application is executed, a photographing user interface including a first region on which an image of a slot to be currently used from a virtual film including multiple slots that store photograph data is output and a second region on which a photograph taken with a camera module is output is provided.

Then, a virtual film capable of taking a photograph for printing is purchased from the user interface provided when the photo printing camera application is executed (S920).

Herein, if an already purchased virtual film is present in the user device, the photographing user interface can be provided without S920.

As described above, the number of slots remaining in any one of virtual films is displayed on the photographing user interface, and if there is no remaining slot, a button and user interface to purchase a virtual film may be provided. That is, a virtual film purchase user interface that supplies price information of one or more virtual films, characteristic information of each virtual film, and the number of slots in each virtual film is provided.

If the purchase of a virtual film is completed or there is an already purchased virtual film, photographing is performed through the photographing user interface (S930).

Thus, the image taken with the camera module and a photograph image fixed by the user's choice are displayed on the photographing user interface.

Then, virtual film development is performed to the photograph on a slot of a currently used virtual film (S940).

That is, data of photographs determined to be printed by the user are mapped and stored on the slot of the virtual film.

For reference, the photo printing camera application can provide not only the photographing user interface but also the user interfaces and functions described above with reference to FIG. 2 to FIG. 8.

Then, if all slots in a virtual film are exhausted or the user selects to print a photograph, a request for photo printing including photograph data for each slot in the virtual film is uploaded to the server to request photo printing (S950).

Thus, the service server 200 that receives the request for photo printing may select a suitable photo printing provider or kiosk based on the request or location of the user device and transmit the request for photo printing. Further, the user device may receive information about one or more photo printing companies or kiosks through the service server 200, select a target to be requested for photo printing, and transmit the request for photo printing.

The photo printing provider device or kiosk that receives the request for photo printing may perform photo printing according to photo printing conditions (number of printings for each slot in a virtual film and printing completion date) selected by the user and perform photo packaging to perform delivery or transfer the photographs.

Hereinafter, a photo printing service system and a photo printing service method using a shared film according to another embodiment of the present disclosure will be described in detail with reference to FIG. 10 to FIG. 13.

A photo printing service using a shared film to be described later according to an embodiment of the present disclosure refers to a service for sharing a limited number of digital films by a large number of users and taking and printing photographs to share actual photographs rather than sharing digital photographs among multiple users.

Hereinafter, an apparatus and method of providing a photo printing service using a shared film according to another embodiment of the present disclosure will be described in detail with reference to FIG. 10 to FIG. 13.

FIG. 10 is a configuration diagram showing a photo printing service system using a shared film in accordance with another embodiment of the present disclosure.

As illustrated in FIG. 10, a photo printing service system includes multiple user devices 500-1, 500-2, 500-N, a photo printing service server 600, a photo printing provider device 700 (display as “photo printing company device” in FIG. 10), and a photo printing kiosk 800.

Each of the user devices 500-1, 500-2, 500-N may be an intelligent device, such as a smartphone, in which various functions are provided or various programs (e.g., mobile applications, etc.) can be freely provided and installed, and provides a photo printing camera application.

A first user device 500-1 includes a communication module 510, a memory 520, a processor 530, and a camera module 540. The user device 500-1 may have the same configuration as the other user devices 500-2, 500-N.

The communication module 510 performs data communication with each of the photo printing service server 600, the photo printing provider device 700, and the photo printing kiosk 800 under the control of the processor 530. Further, the communication module 510 can also perform direct communication with the other devices 500-2, . . . 500-N to perform operations related to photographing and photo printing services using a shared film under the control of the processor 530.

The memory 520 stores a photo printing camera application program. The photo printing camera application program stored in the memory 520 is driven by the processor 530.

Herein, the memory 520 may collectively refer to a non-volatile storage device that retains information stored therein even when power is not supplied and a volatile storage device that requires power to retain information stored therein.

Further, the memory 520 may function to temporarily or permanently store data processed by the processor 530. Herein, the memory 520 may include magnetic storage media or flash storage media in addition to the volatile storage device that requires power to retain information stored therein, but the present disclosure is not limited thereto.

The processor 530 executes the photo printing camera application program stored in the memory 520 and controls general operations for providing photographing and photo printing services using a shared film.

To this end, the processor 530 may be implemented including at least one processing unit (CPU, micro-processor, DSP, etc.), a RAM (Random Access Memory), a ROM (Read-Only Memory), etc. and reads the program stored in the memory 520 through the RAM and executes the program through at least one processing unit Further, in some embodiments, the term “processor” may be construed as having the same meaning as the terms “controller”, “operator, “control unit”, etc.

The procedure of a photo printing service using a shared film provided through the photo printing camera application according to another embodiment of the present disclosure can be roughly described as follows.

A user may purchase online a virtual film capable of taking and storing multiple photographs through the photo printing camera application in the user device 500-1. Herein, the purchase of the virtual film may include payment for a photo printing service for photograph data stored in the film.

Further, a virtual film to be described below can be shared and used by multiple users (members) and each virtual film includes multiple slots in which photograph data are stored. Hereinafter, a virtual film shared and used by multiple members will be referred to as “shared film”. For reference, the user can purchase and use a virtual film to be used by the user only (i.e., unshared film) in addition to a shared film to be shared with other users, and photographing and photo printing methods using the unshared film are identical or similar to those using a share film.

Then, the user may select the shared film purchased though the user device 500-1 and take a photograph through the photo printing camera application. All of a predetermined number of slots in the shared film may be exhausted, or a request for photo printing for photograph data of at least one slot stored in the shared film or for the shared film may be transmitted to the photo printing service server 600, the photo printing provider device 700, and the photo printing kiosk 800 through the photo printing camera application according to the user's choice.

To provide the photo printing camera application, the processor 530 performs the following processes when the photo printing camera application program is executed.

The processor 530 provides a photographing user interface that enables photographing with a shared film which is shared with one or more other members and includes multiple slots that individually store photograph data. The user interface provided through the photo printing camera application has a concept including a graphic user interface (GUI).

Further, the processor 530 stores a photograph taken with the camera module 540 in an unused slot among the multiple slots of the shared film and exhausts the slot. Further, the processor 540 transmits photograph data for each slot stored in the shared film to at least one of the photo printing service server 600, the photo printing provider device 700, and the photo printing kiosk 800 which are already interworking with the processor 530 in order for a photograph to be printed for each of the members sharing the shared film.

In this case, the processor 530 transmits used slot information about an exhausted slot to the photo printing service server 600 whenever a photograph is taken using the shared film on the photo printing camera application. This is to perform an exhaustion process to the slot (i.e., exhausted slot) in user devices of the other members using the shared film. Further, the processor 530 receives shared information about a slot exhausted when the shared film is used by user devices of the other members from the photo printing service server 600 in real time. Therefore, the processor 530 synchronizes an exhaustion process for a slot corresponding to the shared information (i.e., information about the slot used by another user) on the shared film.

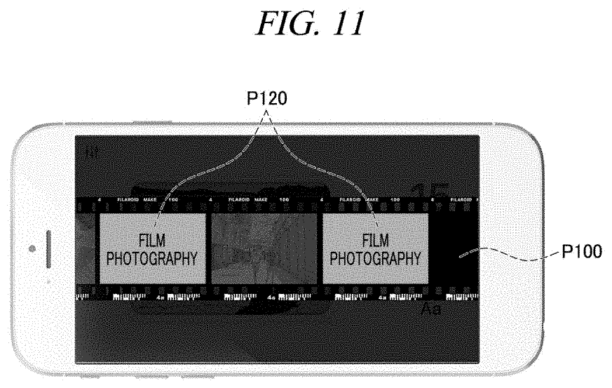

The method of providing a photo printing service through the photo printing camera application will be described in more detail with reference to FIG. 11 to FIG. 13.

The photo printing service server 600 performs operations for the photo printing service while interworking with the photo printing camera application driven on each of the user devices 500-1, 500-2, 500-N.

As shown in FIG. 10, the photo printing service server 600 includes a communication module 610, a memory 620, and a processor 630.

The communication module 610 performs data communication with each of the user devices 500-1, 500-2, 500-N and the linked photo printing provider device 700 and photo printing kiosk 800.

The memory 620 stores a photo printing service program configured to provide a photo printing service using a shared film to the user devices 500-1, 500-2, 500-N.

The processor 630 executes the program stored in the memory 620 and performs processes corresponding to respective operations of the photo printing camera application program to be processed by the processor 530 of the user device 500-1 which will be described later.

The processor 630 matches each user device that purchases a shared film with user identification information, information about the purchased shared film, and identification information of each member sharing the shared film and stores them. Herein, the processor 630 may receive a request for purchase of a shared film including identification information of a shared film selected by a certain user device, the number of members to share the shared film, and information about each of the other members to share the shared film, and match and store the identification information of the selected shared film, the number of the members, and the information about each of the other members. Further, the processor 630 may issue a new shared coupon number for the selected shared film to the user device that transmits the request for purchase of a shared film and then match the shared coupon number with the information about the shared film and store them.

Further, after receiving an acceptance of purchase of the shared film including the shared coupon number for the shared film from all of the user devices of the other members, the processor 630 may transmit sharing approval information to the user device that transmits the request for purchase of a shared film to perform a payment process for the shared film.

Herein, the processor 630 transmits a shared film purchase approval request to each of the user devices of the other members based on the already stored information about each of the other members. Then, if the processor 630 receives an acceptance of purchase of the shared film including the shared coupon number for the shared film from all of the user devices of the other members in response to the shared film purchase approval request, the processor 630 may transmit sharing approval information to the user device that transmits the request for purchase of a shared film to perform a payment process for the shared film.

For another example, the processor 630 may also transmit a shared film purchase approval request in the form of any one of a pop-up message output through the photo printing camera application of the user devices of the other members, a message transmitted by a predetermined communication mode (e.g., SMS or MMS), and a message added to an alert pop driven on the operation system of the user device.

Further, after receiving an acceptance of purchase of the shared film corresponding to the shared film purchase approval request from the user devices of the other members, the processor 630 may transmit sharing approval information to the user device that transmits the request for purchase of a shared film to perform a payment process for the shared film.

Meanwhile, the processor 630 receives a request for photo printing including photograph data stored in at least some of multiple slots of a shared film from a previously registered user device. In this case, the processor 630 checks previously stored identification information of other multiple members for the shared film requested for photo printing and transmits a request for photograph data of the shared film to user devices of the other members based on the checked identification information of the other members.

Further, the processor 630 receives photograph data for each slot used in the shared film from at least one of the user devices of the other members in response to the request for photograph data. The processor 630 gathers and manages photograph data for each slot of the shared film used by all the members in response to the received request for photo printing of the shared film from a certain user device.

Furthermore, when photograph data of all slots in a shared film requested for photo printing is completely received, the processor 630 performs a predetermined photo printing process. For example, the photo printing process may refer to transmission of a request for photo printing including photograph data of all slots of the shared film and delivery information of all the members to the previously linked photo printing provider device 700 or photo printing kiosk 800.

The operations performed by the processor 630 are not limited to interworking with any one user device and can be performed interworking with each of all user devices connected thereto.

Meanwhile, each of the photo printing provider device 700 and the photo printing kiosk 800 is a device managed or installed in a certain place and receives a virtual film (i.e., a shared or unshared film including multiple photograph data) provided through each of the user devices 500-1, 500-2, 500-N or the photo printing service server 600.

Each of a printing provider that manages the photo printing provider device 700 and the photo printing kiosk 800 can perform photo printing for the received virtual film, package a printed photograph as a product, and deliver the photograph product using delivery information set for each virtual film. Further, the printing company or the photo printing kiosk may transfer the packaged photograph product to a user who visits the printing company or the photo printing kiosk offline, through an authentication process.

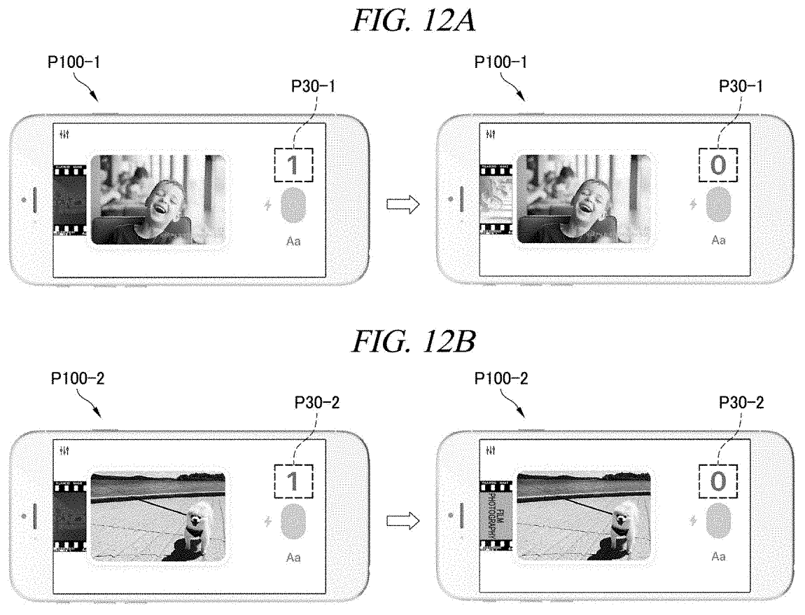

Hereinafter, general functions of the photo printing camera application provided under the control of the processor 530 of the user device 500-1 will be described with reference to FIG. 11 and FIG. 12.

The virtual film described above with reference to FIG. 2 to FIG. 8 can be substituted with a shared film. That is, the photo printing camera application according to another embodiment of the present disclosure includes all the functions described above with reference to FIG. 2 to FIG. 8. For convenience in explanation, an explanation of the same functions and operations as those of the photo printing camera application described above with reference to FIG. 2 to FIG. 8 will not be provided. A distinct function of the photo printing camera application using a shared film according to another embodiment of the present disclosure will be mainly described.

The processor 530 provides a photographing user interface including a first region P10 where an image corresponding to a slot to be currently used among multiple slots in a shared film, a second region P20 where an image taken with the camera module 540 is output, a third region P30 where the number of available slots remaining in the virtual film is displayed, and a fourth region P40 where a camera button to control camera photographing is output. Herein, the photographing user interface may further include a fifth region P50 where a comment input button that enables the user to input and record a comment into the photograph is output.

If photographing is performed through the camera module 540 on the photographing user interface, the processor 530 assigns a photograph output on the second region P20 to a slot corresponding to an image output on the first region P10 and exhausts the slot. Herein, whenever an exhaustion process is performed to a slot of the shared film, the processor 530 displays a reduced number of remaining slots on the third region P30. Further, if the processor 530 receives shared information indicating that a slot of the shared film is used by another member from the photo printing service server 600, the processor 530 displays a reduced number of remaining slots on the third region P30 according to the synchronized exhaustion process.

That is, when a slot of the shared film is used by the user device 500-1 or when a certain slot of the shared film is used by a user device of another member, the photographing user interface displays a reduced number of remaining slots in real time.

If a predetermined user interactive action (e.g., click, swipe, slide, etc.) occurs on the slot image output on the first region P10 through the photographing user interface, the processor 530 may provide a film replacement function to replace the shared film with one of multiple virtual films (i.e., shared or unshared films) purchased by the user.

Hereinafter, a process of handling the purchase of a shared film by the processor 530 will be described.

If there is no virtual film registered (i.e., purchased virtual shared or unshared film) for the user of the user device 500-1 or if there is no slot remaining in a currently selected virtual film among previously purchased virtual films, the processor 530 may output a buy button to a virtual film UI on the first region P10.

Specifically, if the purchase of a virtual film is selected, the processor 530 may provide user interface to select any one of shared films and unshared films. In this case, if the user selects to purchase a shared film, the processor 530 provides a shared film purchase user interface that displays purchase price information of one or more available shared films, characteristic information of each shared film, and the total number of slots in each shared film.

The shared film purchase user interface provides a function to select at least one shared film and a function to make a payment for selected one or more shared films. For reference, the characteristics of a shared film may include various filter effects and the size of a photograph to be printed.

Further, the shared film purchase user interface includes a first function to select a shared film to be purchased, a second function to input the number of members to share the shared film, a third function to input information about the other members, and a fourth function to perform a payment process for the shared film requested to be purchased. The purchase price information on the shared film purchase user interface is changed by the application of shared price depending on the number of members input using the second function to an initially displayed basic purchase price and then displayed. For example, if three members including the user want to share the shared film, the purchase price information is displayed after a certain extra charge (i.e., shared price) is added to the initially displayed basic purchase price.

Further, the processor 530 transmits a request for purchase of a shared film including identification information of the shared film selected using the first function, the number of members input using the second function, and information about each of the other members input using the third function of the shared film purchase user interface to the photo printing service server 600.

Further, if the processor 530 receives sharing approval information from the photo printing service server 600 according to an acceptance from all of the other members in response to the request for purchase of a shared film, the processor 530 performs a payment process for the shared film using the fourth function.

Meanwhile, the shared film purchase user interface may further include a fifth function to select any one of a representative purchase or a group purchase of the shared film selected by the user. Herein, if the user selects the representative purchase, the processor 530 makes a payment of the total purchase price applied with the shared price when performing a payment process. If the user selects the group purchase, the processor 530 makes a payment of a partial payment price determined by dividing the total purchase price applied with the shared price by the number of members when performing a payment process.

Further, if the representative purchase is selected, when the payment process is completed, the processor 530 registers the shared film on the photographing user interface and transmits payment process complete information to the photo printing service server 600 to register the shared film on the user devices of the other members. Further, if the group purchase is selected, the processor 530 receives group payment complete information when all of the members completely make a payment for the shared film from the photo printing service server 600 and then registers the shared film on the photographing user interface.

Meanwhile, when photographs in a shared film are printed, if data of photographs taken using the shared film are transmitted to an external device (i.e., photo printing service server, etc.) in real time, there may be resource waste in the photo printing camera application itself or in communication with the external device. Therefore, when a limited number of slots are all exhausted, the data of photographs taken using the shared film can be uploaded to the external device at one time.

If the data of photographs taken using the shared film are shared in real time by the members, a large amount of data needs to be exchanged in real time between the photo printing camera applications of the respective user devices and the photo printing service server 600.

Therefore, in another embodiment of the present disclosure, when each member takes a photograph using a shared film, photograph data are not actually uploaded in real time to use the shared film, but a user device of each member transmits a token data value including minimal data indicating the use of a slot in the shared film to the photo printing service server 600. That is, each of used slot information transmitted from the processor 530 to the photo printing service server 600 and shared information received from the photo printing service server 600 may be of minimum size token type including only identification information of the shared film and the used slot.

Herein, if the photo printing service server 600 receives a token type data value (i.e., used slot information) from a certain user device, the photo printing service server 600 records identification information of a corresponding member and information about the exhausted slot in the shared film. Then, the photo printing service server 600 transmits a token data value (i.e., shared information) based on accounts of all the members interworking with the shared film or identification information of the user devices.

If the processor 530 receives the shared information from the photo printing service server 600, the processor 530 outputs an identification mark indicating that a slot corresponding to the shared information among multiple slots in the shared film is used by another member, through the photographing user interface. Herein, the identification mark can be output to each of the user devices of the other members except the user device that uses the slot.

FIG. 11 illustrates an example of a user interface to explain a photograph management method on a shared film through a photo printing camera application in accordance with another embodiment of the present disclosure.

As shown in FIG. 11, separate identification information (displayed as “film photography” in FIG. 11) of a slot corresponding to the shared information is displayed on all slot images P100 of a shared film output through a film check page. Therefore, the slot used by the user device 500-1 and the slot corresponding to the shared information are distinguished.

For example, in the slot used by the user device 500-1, a virtually film-developed photograph may be displayed, but in the slot corresponding to the shared information, only minimum identification information without information based on separate photograph data may be displayed. Thus, a predetermined identification mark (e.g., figure shape, etc.) in a space (i.e., a slot) of the shared film is displayed on the user devices of all the members, and, thus, the members can see that another member took a photograph using the slot of the shared film.

Meanwhile, the number in an icon indicating how many times the shared film can be used for photographing (i.e., the number of remaining slots) through the photo printing camera application is reduced and displayed on the user devices of all the members.

FIG. 12 illustrates an example of a user interface to explain a slot exhaustion synchronization method for a shared film through a photo printing camera application in accordance with another embodiment of the present disclosure.

FIG. 12 illustrates an example where the first user device 500-1 and a second user device 500-2 share and use a shared film.

FIG. 12A illustrates a first photographing user interface P100-1 output through a photo printing camera application of the first user device 500-1 and FIG. 12B illustrates a second photographing user interface P100-2 output through a photo printing camera application of the second user device 500-2.

Referring to FIG. 12A and FIG. 12B, the number of remaining slots in each shared film is displayed on each of a third region P30-1 of the first photographing user interface P100-1 and a third region P30-2 of the second photographing user interface P100-2, and it can be seen that the same number is displayed.

In this case, if a user of the first user device 500-1 takes a photograph using the shared film, the photograph is stored in a corresponding slot and virtually film-developed on a slot image simultaneously. Further, the number of remaining slots reduced by 1 (i.e., “0”) is displayed on the third region P30-1. Then, the processor 530 of the first user device 500-1 transmits used slot information of the shared film to the photo printing service server 600.

In parallel with the above process, the second user device 500-2 receives shared information about the photographing of the first user device 500-1 using the shared film from the photo printing service server 600. Therefore, a processor of the second user device 500-2 synchronizes an exhaustion process to the slot of the shared film corresponding to the shared information and displays the number of remaining slots reduced by 1 (i.e., “0”) on the third region P30-2 of the photographing user interface. Herein, in the second photographing user interface P100-2 output on the second user device 500-2, an image of the slot is output on a first region, but the photograph is not displayed as virtually film-developed but an identification mark (displayed as “film photography” in FIG. 12B) indicating the use of the shared film for photographing by another user device is output.

Hereinafter, a process of handling a request for photo printing for a shared film by the processor 530 will be described.

If all slots in a shared film activated on the photographing user interface are exhausted, the processor 530 transmits photograph data for each slot used in the shared film to the photo printing service server 600. If at least one slot of the activated shared film is used and then the user makes an input to select and print a photograph, the processor 530 also transmits photograph data for each slot to the photo printing service server 600.

Referring to FIG. 8, when the number of remaining slots output on the third region P30 of the photographing user interface is “0”, a photo print button P13 is displayed as “PRINT” on the first region P10. In this case, the user can select (e.g., click) the button and intuitively and easily handle the requests for photo printing for the shared film.

The processor 530 provides a photo printing function for each of a manager mode which is activated when the user as a representative makes a request for purchase of a shared film and a member mode which is activated when the user participates as a member in a purchase of a shared film started in a user device of a certain representative, through the photographing user interface.

Herein, if the manager mode is activated, the photographing user interface provides a function to select any one of a representative print mode in which only a representative user who made the request for purchase of the shared film can transmit a request for photo printing for the shared film to at least one of the photo printing service server 600, the photo printing provider device 700, and the photo printing kiosk 800 and a member print mode in which any one of members participating in the purchase of the shared film can transmit a request for photo printing.

For example, if all slots of the shared film are exhausted when the manager mode and the representative print mode are activated, the representative user transmits a request for photo printing.

If all slots of the shared film are exhausted when the manager mode and the member print mode are activated, the user can select to transmit a request for photo printing or receive a request for photograph data from the photo printing service server 600 in response to a request for photo printing from another member and transmit photograph data for each slot used in the shared film.

If all slots of the shared film are exhausted when the member mode is activated, the user may transmit a request for photo printing for the shared film according to a mode (i.e., any one of the manager mode or the member print mode) selected by another member as a representative or receive a request for photograph data in response to a request for photo printing from another member (the representative or a certain member) and transmit photograph data for each slot used in the shared film.

In this case, the request for photo printing may be transmitted to at least one of the photo printing service server 600, the photo printing provider device 700, and the photo printing kiosk 800 according to the user's choice, or may be automatically transmitted to the photo printing service server 600 and then transferred to at least one of the photo printing provider device 700 and the photo printing kiosk 800 under the control of the photo printing service server 600.

Aside from the above process, the processor 530 performs a film backup function to avoid a situation where photographs are lost, such as the loss of the user device. When all slots in a shared film are exhausted or according to the user's choice, the processor 530 performs a backup by uploading user identification information, identification information of the shared film, and photograph data for each slot in the shared film to the photo printing service server 600. In this case, the photo printing service server 600 may transmit a request for photograph data for each slot used by each member of the shared film to be uploaded with photograph data. Further, the photo printing service server 600 may match each member with corresponding photograph data and store them and then gather and manage photograph data of all slots in the shared film. For reference, the photo printing service server 600 stores therein a film purchase history of each user who purchases shared films.

Meanwhile, when the user purchases a shared film or makes a request for photo printing, the processor 530 further provides a delivery information input user interface that enables each member sharing the shared film to input a delivery address at which the member receives printed photographs.

That is, the delivery information input user interface includes a function to input delivery information of at least one member including the user of the user device 500-1, and the input delivery information is transmitted together with at least one of identification information of the at least one member including the user and identification information of the shared film to at least one of the photo printing service server 600, the photo printing provider device 700, and the photo printing kiosk 800 and then registered.

For example, if the user device 500-1 as a representative transmits a request for photo printing, the processor 530 may perform a photograph upload process of uploading all photographs in the shared film to the photo printing service server 600, a delivery check process of outputting the input delivery address for each member to be checked by the user when the user pays for the shared film or makes a request for photo printing, a delivery information change process of receiving modified information if the user wants to modify the delivery address, and an order complete process of finally completing an order of printing. For reference, after the order complete process, the photo printing service server 600 may make a request for uploading of photograph data for each slot used to the user devices of the other members for the shared film, gather the uploaded photograph data for each slot of all the members, print all photographs of the shared film for each of the members, and then deliver or distribute the printed photographs.

For reference, the printed photographs of the shared film may be primarily packaged in a branded film envelope of a photo printing service provider and secondarily packaged in a mail envelope or the like and then delivered to each of the members. The film envelope may have design elements to facilitate not only packaging but also storage of the photographs. For example, the film envelope may have a hole to be kept as hung on a hook and a date marked on the film envelope to indicate when the film is printed, and at least some of film envelopes may have different colors to distinguish years or months.

Meanwhile, the photo printing service server 600 may transmit a request for photo printing to the provider device 700 or photo printing kiosk 800 close or adjacent in distance to the user based on the delivery addresses of the respective members. To this end, each of the photo printing service provider device 700 and the photo printing kiosk 800 may include a communication module configured to perform data communication with each user device or the photo printing service server 600, a processor configured to control a photo printing service, and a memory that stores a photo printing service program.

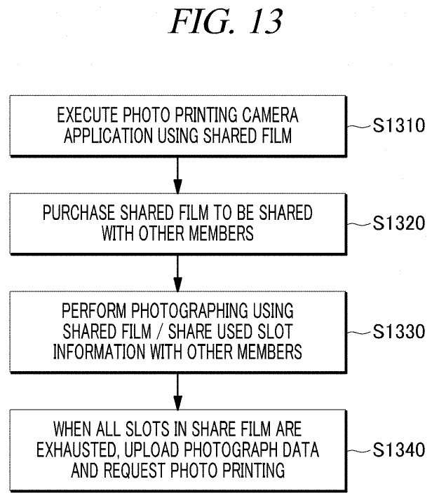

Hereinafter, a photo printing service method using a shared film according to another embodiment of the present disclosure will be described in detail with reference to FIG. 13.

The following processes can be performed by the processor 530 of the apparatus of providing a photo printing camera application (i.e., user device).

FIG. 13 is a flowchart provided to explain a photo printing service method using a shared film through a photo printing camera application in accordance with another embodiment of the present disclosure.

In a user device, a photo printing camera application is executed (S1310).

In this case, the photo printing camera application program is provided in the user device and the photo printing camera application program can be downloaded by access to the photo printing service server, or can be downloaded from a separate market from which mobile applications can be downloaded.

When the photo printing camera application is executed, a photographing user interface including a first region on which an image of a slot to be currently used from a shared film being shared with one or more members is output, a second region on which a photograph taken with a camera module is output, and a third region on which the number of slots remaining in the shared film is displayed is provided.

The photo printing camera application can output the photographing user interface and also provide the user interfaces and the functions described above with reference to FIG. 2 to FIG. 8.

Then, a shared film to be shared with other members is purchased through the shared film purchase user interface provided by executing the photo printing camera application (S1320).

Herein, the shared film purchase user interface interworks with the photographing user interface. If an already purchased shared film is present in the user device, the photographing user interface can be provided without S1320.

As described above, the number of slots remaining in any one of shared films is displayed through the photo printing camera application, and if there is no remaining slot, a user interface to purchase a shared film may be provided. That is, a shared film purchase user interface that supplies price information of one or more shared films, characteristic information of each shared film, and the number of slots in each virtual film is provided.

A configuration of the shared film purchase user interface and a process of purchasing a shared film through the shared film purchase user interface are identical or similar to the above-described configuration and method, respectively. Therefore, a detailed explanation thereof will not be provided.

If the purchase of a shared film is completed or there is an already purchased shared film, a photographing user interface is provided through the photo printing camera application and photographing is performed through the photographing user interface (S1330).

That is, the photographing user interface that enables photographing with a shared film is provided, and, thus, an image taken with a camera module and a photograph image fixed by the user's choice are displayed on the photographing user interface. Then, virtual film development may be performed to the photograph on a slot image of a currently used shared film.

Further, the photograph taken with the camera module is stored in an activated and unused slot on the photographing user interface and then, the slot is exhausted. Whenever a photograph is taken using the shared film, used slot information about an exhausted slot is transmitted to the photo printing service server 600.

In parallel with the above process, if shared information about an exhausted slot is received in real time from the photo printing service server 600 when a corresponding shared film is used on a user device of another member, an exhaustion process to a slot corresponding to the shared information is synchronized on the shared film. Herein, when the shared information is received from the photo printing service server 600, a reduced number of remaining slots is displayed on the third region P30 according to the synchronized exhaustion process.

Each of the used slot information and the shared information may be of minimum size token type including only identification information of the shared film and the used slot. Further, if the shared information is received from the photo printing service server 600, an identification mark indicating that a slot corresponding to the shared information among multiple slots in the shared film is used by another member may be output on the photographing user interface. Herein, the identification mark can be output to each of the user devices of the other members for the shared film except the user device that uses the slot.

Then, if all slots in a shared film are exhausted or the user selects to print a photograph, a request for photo printing including photograph data for each slot in the shared film or photograph data for each slot used is transmitted to the photo printing service server (S1340).

Specifically, the photographing user interface provides a photo printing function for each of a manager mode which is activated when the user of the user device as a representative makes a request for purchase of a shared film and a member mode which is activated when the user participates as a member in a purchase of a shared film started in a user device of a certain representative.

Herein, if the manager mode is activated, the photographing user interface provides a function to select any one of a representative print mode in which only a representative user who made the request for purchase of the shared film can transmit a request for photo printing for the shared film to at least one of the photo printing service server, the photo printing provider device, and the photo printing kiosk and a member print mode in which any one of members participating in the purchase of the shared film can transmit a request for photo printing.

Thus, the service server 600 that receives the request for photo printing may select a suitable photo printing company (i.e., photo printing provider) or kiosk based on the request or location of the user device and transmit the request for photo printing. Further, the user device may receive information about one or more photo printing companies or kiosks through the service server 600, select a target to be requested for photo printing, and transmit the request for photo printing. The photo printing provider device or kiosk that receives the request for photo printing may perform photo printing according to photo printing conditions (number of printings for each slot in a virtual film and printing completion date) selected by the user and perform photo packaging to perform delivery or transfer the photographs.

The above-described method of providing a photo printing camera application according to an embodiment of the present disclosure and the above-described photo printing service method using a shared film according to another embodiment of the present disclosure can be embodied in a storage medium including instruction codes executable by a computer such as a program module executed by the computer. A computer-readable medium can be any usable medium which can be accessed by the computer and includes all volatile/non-volatile and removable/non-removable media. Further, the computer-readable medium may include all computer storage and communication media. The computer storage medium includes all volatile/non-volatile and removable/non-removable media embodied by a certain method or technology for storing information such as computer-readable instruction code, a data structure, a program module or other data. The communication medium typically includes the computer-readable instruction code, the data structure, the program module, or other data of a modulated data signal such as a carrier wave, or other transmission mechanism, and includes a certain information transmission medium.

The method and system of the present disclosure have been explained in relation to a specific embodiment, but their components or a part or all of their operations can be embodied by using a computer system having general-purpose hardware architecture.

The above description of the present disclosure is provided for the purpose of illustration, and it would be understood by a person with ordinary skill in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. A user device that provides a photo printing camera application, comprising:
a communication module;
a memory that stores a photo printing camera application program; and
a processor that executes the program stored in the memory,
wherein upon execution of the photo printing camera application program, the processor provides a photographing user interface including a first region on which an image of a slot to be currently used from a virtual film including multiple slots that store photograph data is output and a second region on which a photograph taken with the camera module is output, and
if photographing is performed through the photographing user interface, the processor assigns the photograph output on the second region to the slot output on the first region and exhausts the slot, and
the processor transmits a request for photo printing including photograph data for each slot stored in the virtual film to at least one of a photo printing service server, a photo printing provider device, and a photo printing kiosk through the communication module.

2. The user device that provides a photo printing camera application of claim 1,
wherein the processor provides a virtual film purchase user interface that supplies price information of one or more virtual films, characteristic information of each virtual film, and the number of slots in each virtual film, and
the virtual film purchase user interface provides a function to select at least one virtual film and a function to make a payment for selected one or more virtual films.

3. The user device that provides a photo printing camera application of claim 1,
wherein the processor provides the photographing user interface that further includes a third region where remaining slot information indicating the number of available slots in the virtual film is output.

4. The user device that provides a photo printing camera application of claim 1,
wherein the processor provides the photographing user interface that further includes a fourth region where a comment input menu that enables a user to input a text into a photograph is output, and
when the comment input menu is selected, the processor further provides a user interface including a region where a tool that enables the user to input a text is output, a region where a text input by the user is output, and a region where a comment input complete menu is output, and
a position of the region where a text input by the user is output is selected and adjusted on the photograph by the user, and
if the comment input complete menu is selected, the text input by the user and photographing time information are marked on the photograph.

5. The user device that provides a photo printing camera application of claim 2,
wherein when a user purchases the virtual film or makes a request for photo printing, the processor further provides a user interface that enables the user to input a delivery address at which the user receives printed photographs, and
the processor transmits the input delivery address together with at least one of identification information of the user and identification information of the virtual film to the photo printing service server.

6. The user device that provides a photo printing camera application of claim 1,
wherein if all slots in a virtual film activated on the photographing user interface are exhausted or if at least one slot of the activated virtual film is used and then a user selects to print a photograph, the processor transmits a request for photo printing.

7. The user device that provides a photo printing camera application of claim 1,
wherein when all slots in the virtual film are exhausted or according to a user's choice, the processor performs a backup by uploading user identification information of the virtual film, identification information of the virtual film, and photograph data for each slot in the virtual film to the photo printing service server.

8. The user device that provides a photo printing camera application of claim 1,
wherein if a predetermined user interactive action occurs on the photograph output on the second region, the processor marks the photograph on the second region onto the slot of the virtual film output on the first region.

9. The user device that provides a photo printing camera application of claim 1,
wherein the processor provides a film check user interface that enables a user to select any one purchased virtual films and output images of all slots in the selected virtual film, and
if a predetermined user interactive action occurs according to a direction in which multiple slots are connected on the all slot images of the virtual film output through the film check user interface, the processor changes positions of the currently output slots of the virtual film on the film check user interface according to the direction of the user interactive action.

10. The user device that provides a photo printing camera application of claim 1,
wherein if a predetermined user interactive action occurs on a slot image output on the first region, the processor provides a film replacement user interface that enables a user to replace the virtual film with one of multiple virtual films purchased by the user.

11. The user device that provides a photo printing camera application of claim 1,
wherein the processor provides a virtual film gift user interface that enables a user to give a virtual film for a gift to another user, and
the virtual film gift user interface includes a menu to input information about a person to receive a virtual film for a gift, a menu to select the kind or price of a virtual film for a gift, and a menu to pay for the selected virtual film or price, and
the results of the processes performed through the respective menus are transmitted to the photo printing service server, and
if the virtual film for a gift or the price of the virtual film is selected and paid, the photo printing service server generates a virtual film activation code corresponding to the paid virtual film or price and transmits the virtual film activation code to a user device corresponding to the person.

12. The user device that provides a photo printing camera application of claim 1,
wherein the processor provides a user interface that enables a user to select one or more slots form among all slots in the virtual film and make an additional order for the number of printings for each of the selected slots before transmitting the request for photo printing.

13. A method of providing a photo printing camera application, comprising:
providing a photographing user interface including a first region on which an image of a slot to be currently used from a virtual film including multiple slots that store photograph data is output and a second region on which a photograph taken with a camera module is output;
if photographing is performed through the photographing user interface, assigning the photograph output on the second region to the slot output on the first region and exhausting the slot; and
transmitting a request for photo printing including photograph data for each slot stored in the virtual film to at least one of a photo printing service server, a photo printing provider device, and a photo printing kiosk.

14. The method of providing a photo printing camera application of claim 13, further comprising:
before the step of providing of the photographing user interface,
providing a virtual film purchase user interface that supplies price information of one or more virtual films, characteristic information of each virtual film, and the number of slots in each virtual film,
wherein the virtual film purchase user interface provides a function to select at least one virtual film and a function to make a payment for selected one or more virtual films, and
the photographing user interface further includes a third region where remaining slot information indicating the number of available slots in the virtual film is output.

15. A user device that provides a photo printing camera application, comprising:
a camera module;
a communication module;
a memory that stores a photo printing camera application program configured to perform photographing and photo printing services using a shared film; and
a processor that executes the program stored in the memory,
wherein upon execution of the photo printing camera application program, the processor provides a photographing user interface that enables photographing with a shared film which is shared with one or more other members and includes multiple slots that individually store photograph data, stores a photograph taken with the camera module in an unused slot among the multiple slots and exhausts the slot, transmits photograph data for each slot stored in the shared film to at least one of a photo printing service server, a photo printing provider device, and a photo printing kiosk which are already interworking with the processor in order for a photograph to be printed for each of the members sharing the shared film, and
the processor transmits used slot information about an exhausted slot to the photo printing service server whenever a photograph is taken using the shared film, and
if the processor receives shared information about a slot exhausted when the shared film is used by user devices of the other members from the photo printing service server in real time, the processor synchronizes an exhaustion process for a slot corresponding to the shared information on the shared film.

16. The user device that provides a photo printing camera application of claim 15,
wherein the photographing user interface includes a first region on which an image of a slot to be currently used from the shared film is output, a second region on which a photograph taken with the camera module is output, and a third region on which remaining slot information indicating the number of available slots in the shared film is output, and
if photographing is performed through the photographing user interface, the processor assigns the photograph output on the second region to the slot output on the first region and exhausts the slot, and displays a reduced number of remaining slots on the third region whenever an exhaustion process is performed, and
if the processor receives the shared information from the photo printing service server, the processor displays a reduced number of remaining slots on the third region according to the synchronized exhaustion process.

17. The user device that provides a photo printing camera application of claim 16,
wherein each of the used slot information and the shared information is of minimum size token type including only identification information of the shared film and the used slot.

18. The user device that provides a photo printing camera application of claim 17,
wherein if the processor receives the shared information from the photo printing service server, the processor outputs an identification mark indicating that a slot corresponding to the shared information among multiple slots in the shared film is used by another member on the photographing user interface, and
the identification mark is output to each of the user devices of the other members for the shared film except a user device that uses the slot.

19. The user device that provides a photo printing camera application of claim 15,
wherein the processor provides a shared film purchase user interface that displays purchase price information of one or more available shared films, characteristic information of each shared film, and the total number of slots in each shared film and includes a first function to select a shared film to be purchased, a second function to input the number of members to share the shared film, a third function to input information about the other members, and a fourth function to perform a payment process for the shared film requested to be purchased, and
the processor transmits a request for purchase of a shared film including identification information of the shared film selected using the first function, the number of members input using the second function, and information about each of the other members input using the third function to the photo printing service server, and
if the processor receives sharing approval information from the photo printing service server according to an acceptance from all of the other members in response to the request for purchase of a shared film, the processor performs a payment process for the selected shared film using the fourth function, and
the purchase price information is changed by the application of shared price depending on the number of members input using the second function to an initially displayed basic purchase price and then displayed.

20. The user device that provides a photo printing camera application of claim 19,
wherein the shared film purchase user interface further includes a fifth function to select any one of a representative purchase or a group purchase of the selected shared film, and
if the representative purchase is selected, the processor makes a payment of the total purchase price applied with the shared price when performing a payment process, and
if the group purchase is selected, the processor makes a payment of a partial payment price determined by dividing the total purchase price applied with the shared price by the number of members when performing a payment process.

21. The user device that provides a photo printing camera application of claim 20,
wherein if the representative purchase is selected, when the payment process is completed, the processor registers the shared film on the photographing user interface and transmits payment process complete information to the photo printing service server to register the shared film on the user devices of the other members, and
if the group purchase is selected, the processor receives group payment complete information when all of the members completely make a payment for the selected shared film from the photo printing service server and then registers the shared film on the photographing user interface.

22. The user device that provides a photo printing camera application of claim 20,
wherein the photographing user interface provides a photo printing function for each of a manager mode which is activated when a user as a representative makes a request for purchase of a shared film and a member mode which is activated when a user participates as a member in a purchase of a shared film started in a user device of a certain representative, and
if the manager mode is activated, the photographing user interface provides a function to select any one of a representative print mode in which only a representative user who made the request for purchase of the shared film transmits a request for photo printing for the shared film to at least one of the photo printing service server, the photo printing provider device, and the photo printing kiosk and a member print mode in which any one of members participating in the purchase of the shared film transmits a request for photo printing.

23. The user device that provides a photo printing camera application of claim 19,
wherein the processor provides a delivery information input user interface that enables each member to input delivery address at which the member receives printed photographs of the shared film, and
when a user purchases the shared film or makes a request for photo printing, the delivery information input user interface includes a function to input delivery information of at least one member including the user of the user device, and
the delivery information input user interface transmits the input delivery information together with at least one of identification information of the at least one member including the user and identification information of the shared film to at least one of the photo printing service server, the photo printing provider device, and the photo printing kiosk.

24. The user device that provides a photo printing camera application of claim 16,
wherein the photographing user interface provides a film replacement function to select any one of two or more previously registered shared films and unshared films for replacement, and
if a predetermined user interactive action occurs on a slot image output on the first region, the photographing user interface performs the film replacement function.

25. A photo printing service server interworking with a user device that provides a photo printing camera application using a shared film, comprising:
a communication module;
a memory that stores a photo printing service program; and
a processor that executes the photo printing service program,
wherein upon execution of the photo printing service program, the processor matches each user device that purchases a shared film with user identification information, information about the purchased shared film, and identification information of each member sharing the shared film and stores them, and
if the processor receives a request for photo printing including photograph data stored in at least some of multiple slots of a shared film from a previously registered user device, the processor checks previously stored identification information of other multiple members for the shared film requested for photo printing, transmits a request for photograph data of the shared film to user devices of the other members based on the checked identification information of the other members, and receives photograph data for each slot used in the shared film from at least one of the user devices of the other members in response to the request for photograph data, and
when photograph data of all slots in the shared film requested for photo printing are completely received, the processor performs a predetermined photo printing process, and
the shared film is shared by two or more members and includes multiple slots that individually store photograph data.

26. The photo printing service server of claim 25,
wherein if the processor receives a request for purchase of a shared film including identification information of a shared film selected by a certain user device, the number of members to share the shared film, and information about each of the other members to share the shared film, the processor matches and stores the identification information of the selected shared film, the number of the members, and the information about each of the other members, and
the processor issues a new shared coupon number for the selected shared film to the user device that transmits the request for purchase of a shared film and then matches the shared coupon number with the information about the selected shared film and stores them, and
after receiving an acceptance of purchase of the shared film including the shared coupon number for the selected shared film from all of the user devices of the other members, the processor transmits sharing approval information to the user device that transmits the request for purchase of a shared film to perform a payment process for the selected shared film.

27. The photo printing service server of claim 25,
wherein if the processor receives a request for purchase of a shared film including identification information of a shared film selected by a certain user device, the number of members to share the shared film, and information about each of the other members to share the shared film, the processor matches and stores the identification information of the selected shared film, the number of the members, and the information about each of the other members, and
the processor transmits a request for approval of purchase of a shared film to the user devices of the other members based on the information about each of the other members, and
after receiving an acceptance of purchase of the shared film from all of the user devices of the other members in response to the request for approval of purchase of a shared film, the processor transmits sharing approval information to the user device that transmits the request for purchase of a shared film to perform a payment process for the selected shared film, and
the request for approval of purchase of a shared film is in the form of any one of a pop-up message output through the photo printing camera application of the user devices of the other members, a message transmitted by a predetermined communication mode, and a message added to an alert pop.
